(19) United States
(12) Patent Application Publication
(10) Pub. No.: US 2009/0121567 A1
(43) Pub. Date: May 14, 2009

(54) AIRFLOW GENERATOR

(75) Inventors: Te-Chang Chou, Hikou Township (TW); Sin-Wei He, Jhudong Township (TW)

Correspondence Address: EGBERT LAW OFFICES, 412 MAIN STREET, 7TH FLOOR, HOUSTON, TX, 77002, US

(73) Assignee: FORCECON TECHNOLOGY Co., Ltd., Chu Pei City (TW)

(21) Appl. No.: 11/939,410

(22) Filed: Nov. 13, 2007

(51) Int. Cl. H02K 7/06; H02K 7/106; H02K 7/12

(52) U.S. Cl. 310/77; 310/80

(57) ABSTRACT

The present invention provides an airflow generator, which includes a plate with a rotary portion and a swinging end. The airflow generator also includes a magnetic brake unit coupled with the rotary portion. The magnetic brake unit has a second magnetizing portion, such that the rotary portion can be coupled with the movable second magnetizing portion. The magnetizing action of the magnetic brake unit enables the second magnetizing portion and the rotary portion to generate reciprocating rotation, thus driving the swinging end to generate oscillating traverse motion. The airflow generator has desirable heat-radiating efficiency, so it will be widely applied to the heat-radiating structure of various lightweight electronic devices and simplified to further cut down the manufacturing costs.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an airflow generator, and more particularly to an innovative airflow generator which oscillates by braking a plate with magnetization principle, and then generates airflow for heat-radiating structure.

2. Description of Related Art Including Information Disclosed Under 37 CFR 1.97 and 37 CFR 1.98.

Electronic devices may generate different degrees of heat depending upon the operating scale and capacity. Among the electronic devices, the radiator fan is a commonly used heat-radiating structure that requires smaller dimensions to meet the thin-profile development trend of electronic devices.

However, since the radiator fan is mainly composed of a rotor, a stator and an annular blade, the volume is limited to a cylindrical space. When the annular blade is reduced to a certain volume, the problem of difficult molding and higher defectiveness rate may occur, while the heat transfer and radiating effect of the rotary fan blade becomes very poor. Thus, this radiator fan is currently applied to space-saving electronic products, such as desktop or notepad computers. As the functionality of some electronic/telecom equipment (e.g. mobile phone, PDA and digital camera) improves quickly and the operating capacity of internal processors achieves a manifold growth than ever before, the heat generated increases considerably.

The currently available palm electronic/telecom equipment generates excessively high temperatures, leading to a negative impact on the electronic components and shortening the service life with higher risk hazards. So, a heat-radiating mechanism is required. Owing to the limitations of volume of the aforementioned radiator fan and inflexibility of the rotary blade, there is a lower possibility of achieving the desired heat-radiating efficiency for compact electronic/telecom equipment.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

As compared with a typical radiator fan disclosed in the prior art, the airflow generator of the present invention could be developed into a compact and flat shape with desirable heat-radiating efficiency, thereby resolving the poor heat-radiating efficiency and bottleneck of typical radiator fan. The airflow generator of the present invention will be widely applied to the heat-radiating structure of various lightweight electronic devices (e.g. mobile phones, PDAs and digital cameras), helping to realize efficient heat-radiation within a compact space.

Based on the structure of the rotary portion of the plate being coupled with the magnetic brake unit, the structure could be simplified to further cut down the manufacturing cost and reduce the assembly space of an airflow generator with better applicability.

With a bending portion arranged between the rotary portion of the plate and swinging end, it is possible to improve the ductility and flexibility of the swinging end of the plate for a better airflow effect.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a side schematic view of the preferred embodiment of the present invention.

FIG. 2 shows a top schematic view of the preferred embodiment of the present invention along with the operation of the plate.

FIG. 3 shows a schematic view of the application of the present invention, wherein the rotary portion of the plate is coupled with the magnetic brake unit.

FIG. 4 shows another schematic view of the application of the present invention, wherein the rotary portion of the plate is coupled with the magnetic brake unit.

FIG. 5 shows a top schematic view of another preferred embodiment of the airflow generator of the present invention.

FIG. 6 shows another side schematic view of a preferred embodiment in FIG. 5.

FIG. 7 shows a schematic view of the application of the present invention, wherein the plate is provided with a bending portion.

FIG. 8 shows another schematic view of the application of the present invention, wherein the plate is provided with bending portion.

FIG. 9 shows a schematic view of the preferred embodiment of the present invention, which is provided additionally with a shell.

FIG. 10 shows a schematic view of the present invention, wherein the airflow generator is applied to an electronic device.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

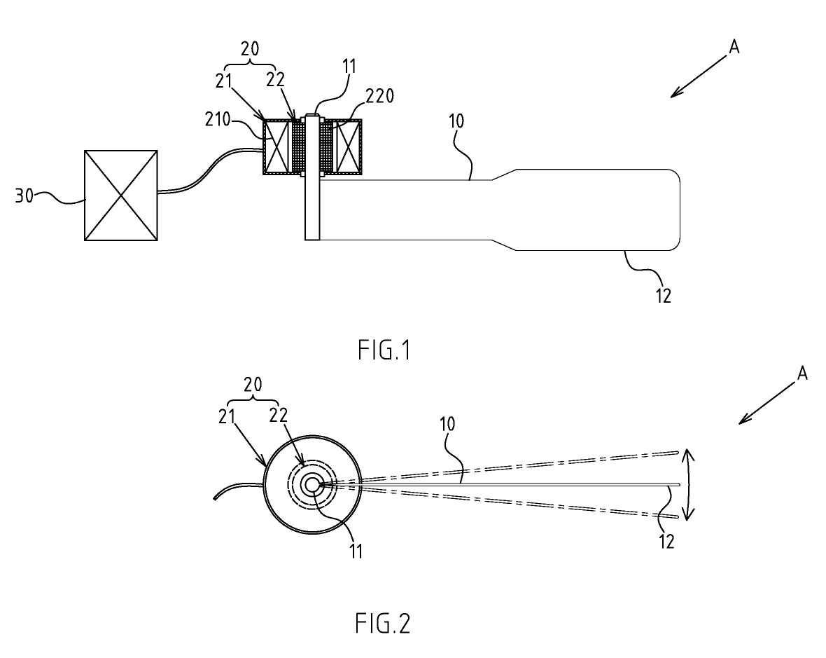

FIGS. 1-2 depict preferred embodiments of airflow generator of the present invention. The embodiments are only provided for explanatory purposes for the patent claims.

The airflow generator A comprises a plate 10, which is a long plate of predefined thickness containing a rotary portion 11 and a swinging end 12 far away from this rotary portion 11. There is a magnetic brake unit 20 linked to the rotary portion 11 of the plate 10. The magnetic brake unit 20 comprises a first magnetizing portion 21 and a second magnetizing portion 22, wherein the first magnetizing portion 21 is set into fixed state, and the second magnetizing portion 22 is set into rotary state. The rotary portion 11 of the plate 10 is coupled with the second magnetizing portion 22. The interactive magnetizing action of the first and second magnetizing portions 21, 22 enables the second magnetizing portion 22 and the rotary portion 11 of the plate 10 to generate a reciprocating rotation, thus driving the swinging end 12 of the plate 10 to generate oscillating traverse motion.

Referring to FIG. 1, said magnetic brake unit 20 is linked to a controller 30, thus controlling the magnetizing change of the second magnetizing portion 22.

Referring to FIGS. 1-2, said first magnetizing portion 21 is composed of a stator 210 (e.g. coils), and the second magnetizing portion 22 is composed of a corresponding rotor 220 (e.g. magnet). The stator 210 is assembled at an exterior of the rotor 220, such that the rotary portion 11 of the plate 10 is adapted with the rotor 220 for simultaneous motion. It is worthy to note that the structure of common stator and rotor generates circulating rotation when it is used in a motor. However, when this structure is used in the present invention, the swinging end 12 of said plate 10 will generate oscillating traverse motion.

Two sensor elements (e.g. Hall elements) are arranged at two positions between the rotor 220 and stator 210 to sense the rotation angle of the rotor 220 and to generate reversing signals to the aforementioned controller 30. The controller 30 is used to switch the magnetizing state of rotor 220 and stator 210, enabling oscillating rotation of the rotor 220 according to preset frequency. Moreover, only a small-angle reciprocating rotation of the rotary portion 11 of the plate 10 allows for oscillating traverse motion of the plate 10, so said rotor 220 and stator 210 can also have a circular shape (e.g. semicircular and quadrant) for achieving the same performance.

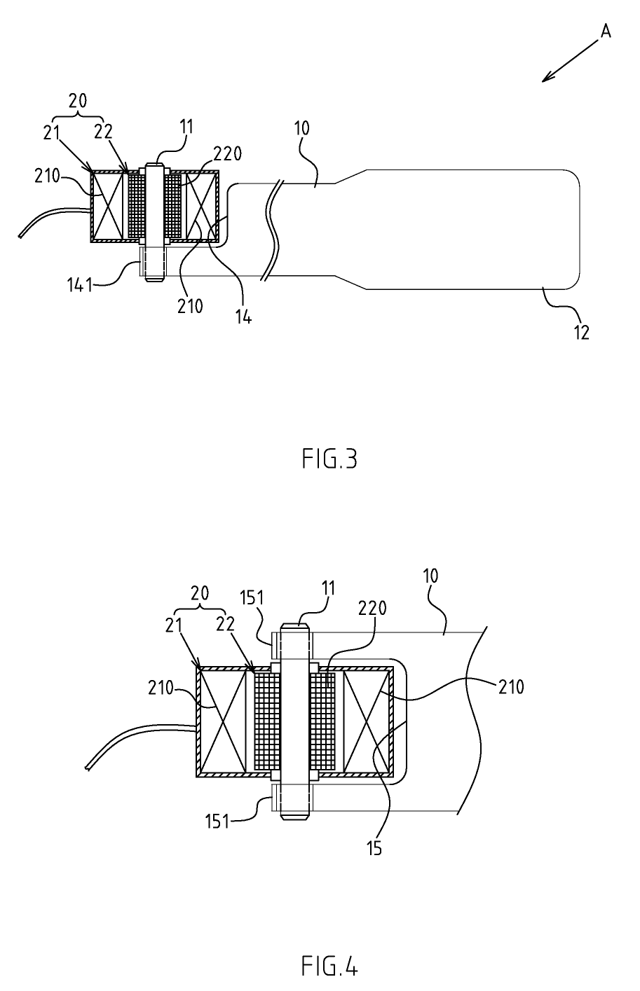

FIG. 3 depicts another preferred embodiment of the rotary portion 11 of the plate 10 coupled with the magnetic brake unit 20. A recessed portion 14 is formed at one side of the plate 10 nearby the rotary portion 11, where one end of the stator 210 of the first magnetizing portion 21 of magnetic brake unit 20 can be inserted to make the magnetic brake unit 20 align with the plate 10. The rotary portion 11 of the preferred embodiment is composed of a single-sided assembly framework 141 and magnetic brake unit 20.

FIG. 4 depicts another preferred embodiment of the rotary portion 11 of the plate 10 linked to the magnetic brake unit 20. A u-shaped recess 15 is arranged centrally between the plate 10 and rotary portion 11, where one end of the stator 210 of the first magnetizing portion 21 of magnetic brake unit 20 can be inserted. Moreover, the rotary portion 11 of the preferred embodiment is composed of double-sided assembly framework 151 and magnetic brake unit 20.

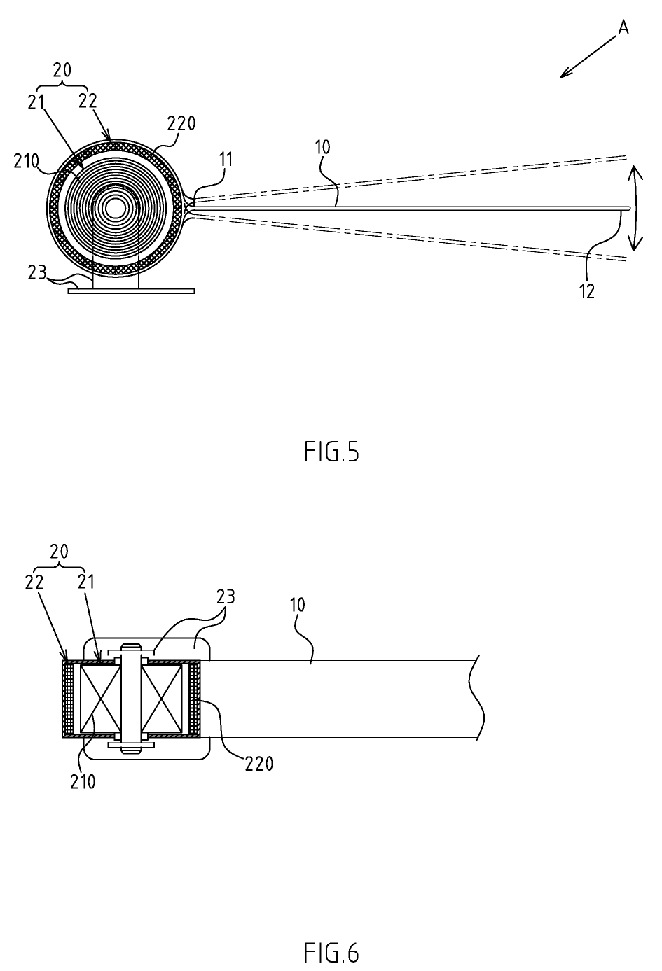

Referring to FIGS. 5 and 6, said rotor 220 is a cylindrical shell surrounding the stator 210, so that the rotary portion 11 of the plate 10 is assembled externally onto the cylindrical shell rotor 220, and the stator 210 is supported securely by a rack 23.

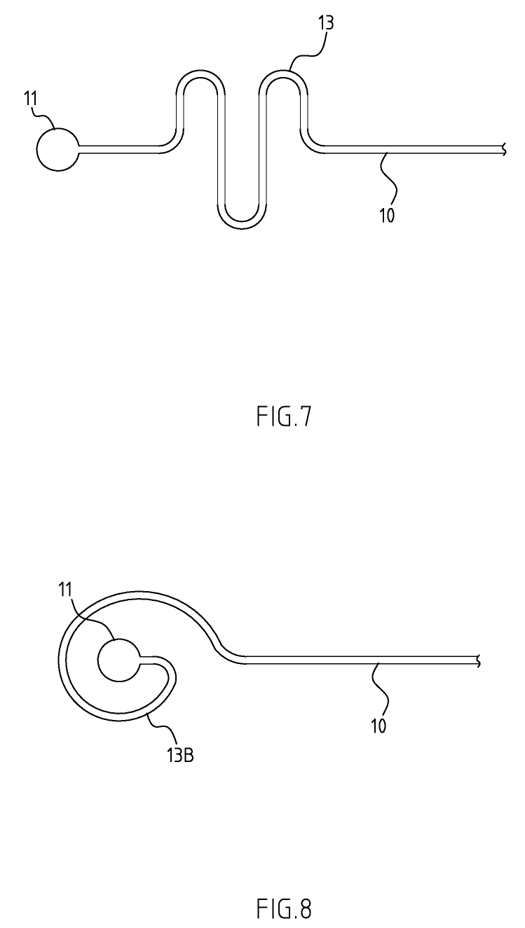

Referring to FIG. 7, a bending portion 13 is arranged between the rotary portion 11 of said plate 10 and the swinging end 12. The bending portion 13 is an S-shaped flexure as shown in FIG. 7. Alternatively, the bending portion 13B has a volute shape as shown in FIG. 8. The bending portion 13 improves the ductility and flexibility of swinging end 12 of the plate 10 for a better airflow effect.

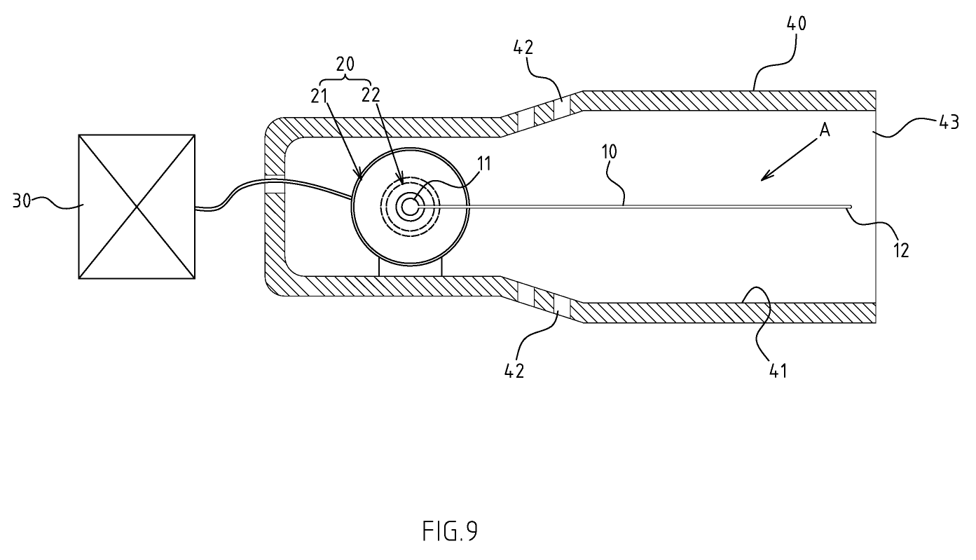

Referring to FIG. 9, said airflow generator A comprises a shell 40 for accommodating the plate 10. The shell 40 is provided with a space 41 for accommodating said plate 10. Inlet port 42 is arranged laterally onto the shell 40, and an outlet port 43 is arranged at one end correspondingly to the swinging end 12 of the plate 10. When the swinging end 12 of the plate 10 swings, air is guided from the inlet port 42 into the space 41 of the shell 40, then discharged from the outlet port 43 through the oscillating traverse motion of the swinging end 12.

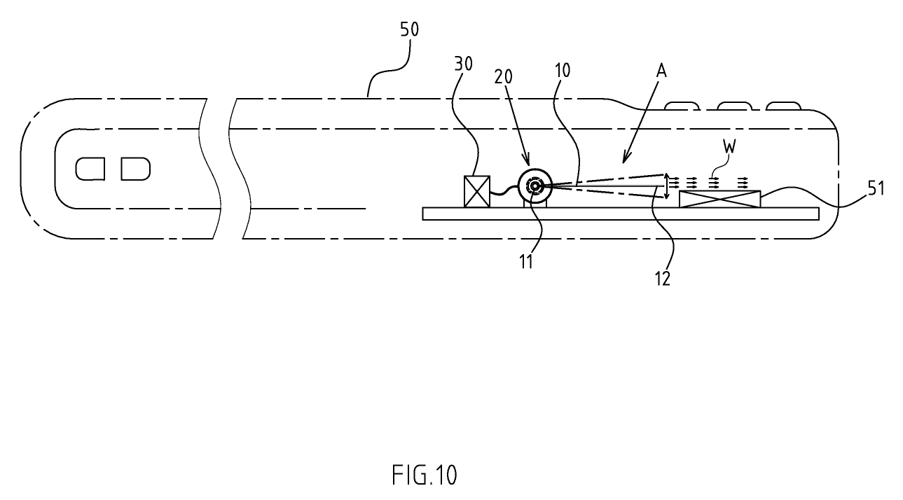

As for the aforementioned airflow generator A, the actual application of plate 10 and magnetic brake unit 20 is shown in FIG. 10, wherein they are assembled onto preset location of the electronic device 50, such as the processor 51 of mobile phone, PDA and digital camera. The controller 30 is used to control the magnetizing change of the magnetic brake unit 20 and to drive the swinging end 12 of the plate 10 to generate oscillating traverse motion, thus leading to airflow similar to fans (shown by arrow W of FIG. 10) and allowing the processor 51 of electronic device 50 to yield heat-radiating effect.

1. An airflow generator, comprising:
a plate, having a length and predefined thickness and containing a rotary portion and a swinging end, said swing end being positioned away from said rotary portion; and
a magnetic brake unit linked to said rotary portion, said magnetic brake unit comprising a first and second magnetizing portion, wherein the first magnetizing portion is set into a fixed state, and the second magnetizing portion being set into a rotary state, said rotary portion being coupled with the second magnetizing portion, the first and second magnetizing portions enabling the second magnetizing portion and said rotary portion to generate reciprocating rotation, driving said swinging end to generate oscillating traverse motion in an interactive magnetizing action.

2. The generator defined in claim 1, wherein the first magnetizing portion comprises a stator, the second magnetizing portion being comprised of a corresponding rotor.

3. The generator defined in claim 2, wherein said stator is assembled at an exterior of the rotor.

4. The generator defined in claim 2, wherein the rotor is assembled externally onto said stator.

5. The generator defined in claim 1, further comprising:
a controller being linked to the first and second magnetizing portions, controlling magnetizing change of the second magnetizing portion.

6. The generator defined in claim 1, wherein said plate has a bending portion arranged between said rotary portion and said swinging end.

7. The generator defined in claim 1, further comprising:
a shell accommodating said plate.
